(19) United States
(12) Patent Application Publication
(10) Pub. No.: US 2017/0341821 A1
(43) Pub. Date: Nov. 30, 2017

(54) MULTI-COMPARTMENT FLEXIBLE PACKAGE

(71) Applicant: Mark Steele, New Prague, MN (US)

(72) Inventor: Mark Steele, New Prague, MN (US)

(21) Appl. No.: 15/480,947

(22) Filed: Apr. 6, 2017

Related U.S. Application Data
(63) Continuation of application No. 12/371,766, filed on Feb. 16, 2009, now abandoned.
Application No. 12/371,766 is a continuation-in-part of application No. 11/857,292, filed on Sep. 18, 2007, now abandoned.
Application No. 11/857,292 is a division of application No. 10/456,971, filed on Jun. 6, 2003, now abandoned.
(60) Provisional application No. 60/386,798, filed on Jun. 6, 2002.
(60) Provisional application No. 61/038,877, filed on Mar. 24, 2008.

(51) Int. Cl. B65D 33/25; B65D 30/22; B65D 75/00; B31B 2160/20; B31B 2155/00

(52) U.S. Cl. CPC B65D 33/2583; B65D 31/12; B65D 33/2566; B31B 2155/00; B31B 2160/20; B31B 2155/002; B65D 75/008

(57) ABSTRACT

A flexible package having multiple compartments is described and depicted. The package can include an internal compartment panel to define first and second package cavities or compartments. Two adjacent but opposing access openings can be provided proximate a top portion of the package to define separate access into the distinct compartments, without a need to open or remove the top or handle portion of the package.

### PRIORITY APPLICATIONS

This application is continuation of U.S. application Ser. No. 12/371,766 filed Feb. 16, 2009, which claims priority to and the benefit of U.S. Provisional Application No. 61/038,877 filed Mar. 24, 2008, and is a continuation-in-part of U.S. application Ser. No. 11/857,292 filed Sep. 18, 2007, now abandoned, which is a division of U.S. application Ser. No. 10/456,971 filed Jun. 6, 2003, now abandoned, which claims priority to and the benefit of U.S. Provisional Application No. 60/386,798 filed Jun. 6, 2002; with each of the identified applications and disclosures being hereby fully incorporated herein by reference.

### FIELD OF THE INVENTION

The present invention relates generally to flexible packaging and, more particularly, to flexible packaging having multiple compartments and corresponding opposing openings.

### BACKGROUND OF THE INVENTION

Conventional flexible packaging does not generally include compartments within the internal cavity of the package. Those packages that do, lack conveniently placed and accessible compartment openings for filling, pouring or otherwise using the separate compartments. Distinct and selectively usable compartments within the cavity are not provided for in these conventional package designs. Further, conventional packages fail to allow for adequate handling of a package with a unique multi-compartment configuration. Moreover, these conventional packages do not provide distinct accessibility or closeability for multiple separate compartments, or the ability to access the separate openings of the compartments without tearing off or otherwise removing the top package seal or handle portion of the package.

As a result, there is a need for a flexible package that substantially solves the above-referenced problems with conventional package designs, configurations, and manufacturing methods.

### SUMMARY OF THE INVENTION

The present invention solves many of the problems that plague conventional flexible packages and packaging methods. Various embodiments of the present invention are directed to two separate and distinct internal compartments within a flexible package. The package is generally formed from a plurality of outer panel portions. These panel portions can include a front panel portion, a back panel portion, and a bottom panel portion. In addition, the main package can include a first side panel portion, and a second side panel portion. The formation of these panels into the package defines at least one internal cavity for holding material contents. Any of the panels can be gusseted with the processes and techniques known to one skilled in the art. The package can further include the segregated internal compartment panel portion having corresponding edge portions joined to or distinguishable from an inner surface of one of the main package panels within the internal cavity to define distinct first and second compartments of the package. Further, the package can include at least two separate openings into the package to enable selectively separate access into the compartments. The openings can include access device, such a re-closeable access device.

A top seal portion of the package is provided intermediate the openings and provides a top dividing portion between the compartments such that the openings open out away from the top seal. Moreover, the package can include one or more handle portions, such as an aperture in the top seal portion of the package. In one embodiment, an alternate slit access opening can be provided on one or more of the outside panels, such as the front or back panels, between the handle portion and the access device. This slit opening enables filling of the package even though the top handle portion may be sealed and the access device closed. As such, the package of the present invention can provide separate accessibility or closeability for multiple separate compartments, or the ability to access the separate openings of the compartments without tearing off or otherwise removing the top package seal or handle portion of the package.

The internal panel can be uniquely sealed within the inner cavity at an inner surface of the front or back panels. Such a package configuration provides convenient and opposing dual accessibility into the compartments.

### BRIEF DESCRIPTION OF THE DRAWINGS

FIG. 1 is a perspective view of a multi-compartment package in accordance with an embodiment of the present invention.

FIG. 2 is a perspective view of an opened multi-compartment package with a top handle portion in accordance with an embodiment of the present invention.

FIG. 3a is a perspective view of a closed multi-compartment package with a top handle portion in accordance with an embodiment of the present invention.

FIG. 3b is a perspective view of a multi-compartment package with a fill slit opening in accordance with an embodiment of the present invention.

FIG. 4 is a side cross-sectional schematic view of a multi-compartment package in accordance with an embodiment of the present invention.

FIG. 5 is close-up schematic view of the multi-compartment package of FIG. 4.

FIG. 5a is close-up schematic view of the multi-compartment package of FIG. 4 with fill slit openings.

FIG. 6 is a side cross-sectional schematic view of a multi-compartment package, with the bottom of the internal compartment sealed a distance above the bottom of the package, in accordance with an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the invention is to cover all modifications, equivalents, and alternatives falling within the spirit and scope of the invention as defined by the appended claims. For illustrative purposes, hatching or shading in the figures is provided to demonstrate sealed portions and/or integrated devices for the package.

### DETAILED DESCRIPTION OF PREFERRED EMBODIMENTS

Referring generally to FIGS. 1-6, a flexible package 10 in accordance with the present invention, and the steps for forming the flexible package 10, are shown. The package 10 generally includes a front panel portion 12, a back panel portion 14, and a bottom panel portion 16. Further, one or more side panel portions (not shown) can be included in various embodiments. Panel portions 12-16 can be joined to form or define an inner cavity of the main package 10 for holding, transporting, or otherwise containing material contents. One or both of the front 12 or back 14 panel portions can include a main sealant surface for bondable joining with selectively positioned portions of an internal compartment panel 30. The joining of the front and back panels 12, 14 can create corresponding side or seal edges 26, 28. Alternatively, the panels 12-16 can be formed of a single web material and folded or formed to define the distinct panel portions. The cross-hatching in the figures is used generally to denote sealing and/or panel edges.

The separate internal compartment panel 30 can be bonded within the package to create or define a first or main compartment 44, and a second compartment 46. The at least one internal compartment panel 30 can include longitudinal compartment panel edges 30a, 30b and a generally transverse compartment bottom edge 30c. As shown in FIG. 1, the compartment panel edges 30a, 30b can correspond with or extend to side edges 26, 28 within the package 10. The package panel portions are generally constructed of flexible sheet material such as polyethylene, polyester, metal foil, polypropylene, or polyethylenes or polypropylenes laminated with other materials such as nylon, polyester, and like films. To provide for higher barriers, embodiments can use combination layers of said materials and material of the like. Generally, the confronting or joinable materials of the main package 10 and the internal compartment panel 30 must have acceptable sealing characteristics for bonding to the respective target material. For instance, the sealant surface of the internal panel 30 can be constructed of a plastic web of polyethylene, or a material with like characteristics and heat bonding qualities for joining to the target main sealant surface (e.g., internal surface) of one of the main package panels, such as the front 12 or back 14 panel portions. One skilled in the art will understand that a myriad of materials and material laminates are available for selective use for the sealant surfaces to facilitate the bonding attachment described herein. In one embodiment, at least one of the sealant surfaces will comprise “contaminants” that permit a varying level of bonding, wherein the level of bondable attachment is dependent on the heat applied from a corresponding heat sealing bar or other device. Higher temperatures will create “destructive” (e.g., permanent) bonds while lower temperatures will create a more temporary bond for selective disengagement. Such bonding techniques can be applied at any sealable surface or region of the main package 10 or the internal compartment panel 30 to create the desired level of bonding.

In one embodiment, the package of the present invention can be formed into a stand-up pouch, but it could be a three-side-seal pouch, a pouch that displays lying down, or other known pouch or packaging designs and configurations. The internal panel 30 can be of the same width and height as the back and/or front panels, or it can be some size smaller, depending on the compartmental needs of the manufacturer or end user. The edges 30a, 30b of the internal compartment panel 30 can be disposed intermediate the front panel 12 and back panel 14 and bonded proximate the bottom portion 16 of the package 10. The side or longitudinal edges 30a, 30b can be bonded in forming the corresponding package seals or edges 26, 28. In embodiments including one or more side panels, the longitudinal edges 30a, 30b can be bonded to the longitudinal edges of just one of the respective front 12 or back 14 panels. Bonding descriptions of the internal compartment panel 30 to various panel designations herein will generally require particular panel portion descriptions for ease of explanation (e.g., panels 12 and 14), but it must be noted that each of the panel portions 12, 14 are interchangeably capable of providing the inner target surface for the internal panel 30 attachment. For instance, specific embodiments will require attachment or bonding of the internal panel 30 to the inner surface of the back panel 14 where the outside surface of the front panel 12 includes graphical indicia. Such attachment of the internal panel 30 to the back panel 14 will protect the indicia on the front panel 12 as specific sealing processes may require sealing bars to contact the outside of the package to bond the internal panel 30 in place.

In one embodiment of the package 10, the internal compartment panel 30 is bonded to the internal sealant surface of the front panel at the transverse edge 30c, with the back panel 14 being free from bonding contact with the transverse edge 30c. Again, the orientation of the panels 12, 14 in relation to the attachment of the internal panel portion 30 is merely for demonstrative purposes and can be interchangeable. As best demonstrated in FIGS. 1-4, the internal panel portion 30 can substantially span the full width or length of the front panel 12. In this embodiment, the longitudinal edges 26, 28 seal and define the width of the package panels 12,14 and the internal compartment panel 30. The transverse edge 30c of the internal panel 30 is attached transverse to the longitudinal edges 26, 28 of the front panel portion 12. The edge or seal 30c can run the entire width of the respective front 12 or back 14 panels or a distance shorter than the corresponding widths of the other panels. For instance, in one embodiment the width of the internal panel 30 can be approximately half the width of the front front 12 or back 14 panels. Other variations in the dimensions and design of the internal panel 30 can be employed without deviating from the spirit and scope of the present invention.

To prevent the internal panel 30, and the transverse edge 30c in particular, from sealing to the back panel 14 during formation and sealing, a barrier material such as Teflon™, Teflon™ coated materials, or materials of like heat barrier qualities and characteristics can be selectively disposed between the back panel 14 and the internal panel 30 proximate the line of the transverse seal or edge 30c. During formation of the package 10, the longitudinal edges 30a, 30b of the internal panel 30 can be bonded intermediate the edges or seals 26, 28 of the front 12 and back panel 14. The described attachment of the internal panel portion 30 defines separate and distinct compartments and cavities.

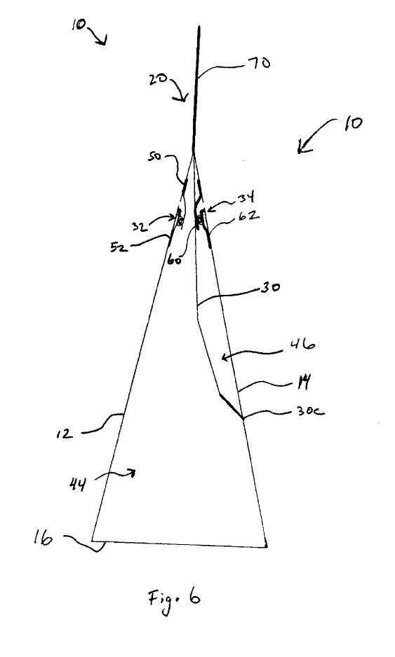

In FIG. 6, another embodiment of the package 10 of the present invention is shown. In this embodiment, the bottom seal or edge 30c of the internal compartment panel 30 is sealed or otherwise disposed along the front panel 12 (or, alternatively, back panel 14) some distance above the bottom of the package 10. Such a configuration permits adjustment of the volumetric capacity of the second compartment 46 in comparison to that of the potentially larger first compartment 44. Again, the edge or seal 30c of the internal compartment panel portion 30 can be sealed to the front panel 12 such that the seal 30c is generally free from bonding contact with the back panel 14. Since seal bars and other bonding mechanisms and techniques known to one skilled in the art are easily utilized and often implement a seal bar across the entire width of the package 10 at the line defined by the transverse edge or seal 30c, it may be necessary to include a material barrier protection along the line of the transverse edge 30c, as disclosed herein. The sealing or attachment of the internal compartment panel 30 to either the front or back panels 12, 14, eliminates the attachment of the panel 30 to the other panels, such as the bottom or side panels. As such, the other flexible panels, gusseted or non-gusseted, are free to expand and contract to accommodate the internal materials or contents in the package 10. A gusseted bottom panel 16 can provide for the stand-up configuration for the package 10 as shown and described herein.

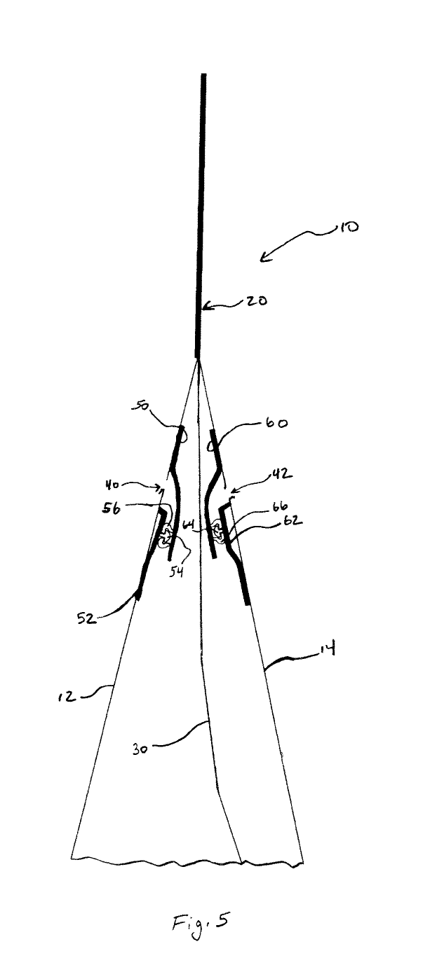

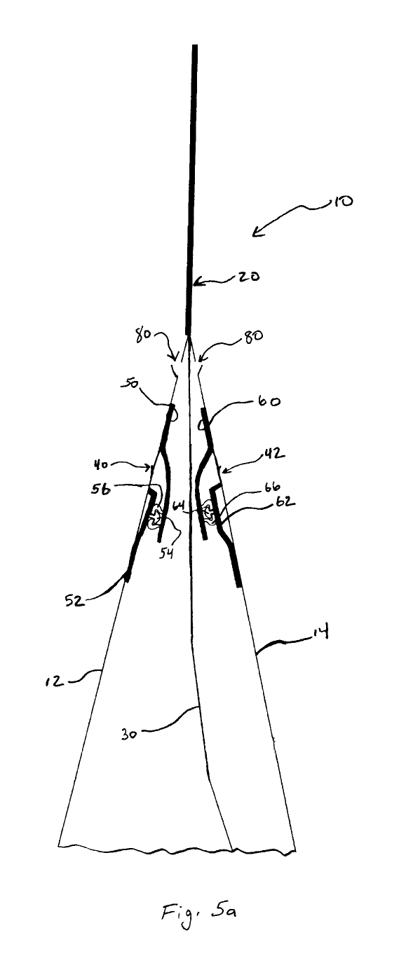

The openings 40, 42 of the package 10 can be accessed via at least one access device. Generally, the at least one access device will include a first device 32 and a second device 34, as shown in FIGS. 1, and 4-6. The first device 32 can include a first flange portion 50, a second flange portion 52, a male profile 54 and a female portion 56. Similarly, the second device 34 can include a first flange portion 60, a second flange portion 62, a male profile 64 and a female portion 66. As best depicted in FIG. 5, the flange portions 50, 52 of the first device 32 are attached or otherwise disposed on the front panel 12 in accordance with known techniques to provide access into the first or main compartment 44 through the first access opening 40. The flange portions 60, 62 are attached or otherwise disposed on the back panel 14 in accordance with known techniques to provide access into the second compartment 46 through the second access opening 42. As such, device 32 can be attached to a single package panel and device 34 can be attached to another single, distinct, package panel, such that the access devices are respectively without attachment to other seals, the internal compartment, and the like. This in turn creates the adjacent but opposing opening design as shown best in FIGS. 1 and 4. The divisional separation of the compartments 44, 46 by the panel 30 starts at the top with the top portion 20 and/or seal 70 and extends down along the dividing internal barrier panel 30 to the bottom seal or edge 30c. The top 20, 70 is generally formed by the joinder or attachment of the tops of the front and back panels 12, 14 together. The top 20, 70 can further include the top of the internal compartment panel 30.

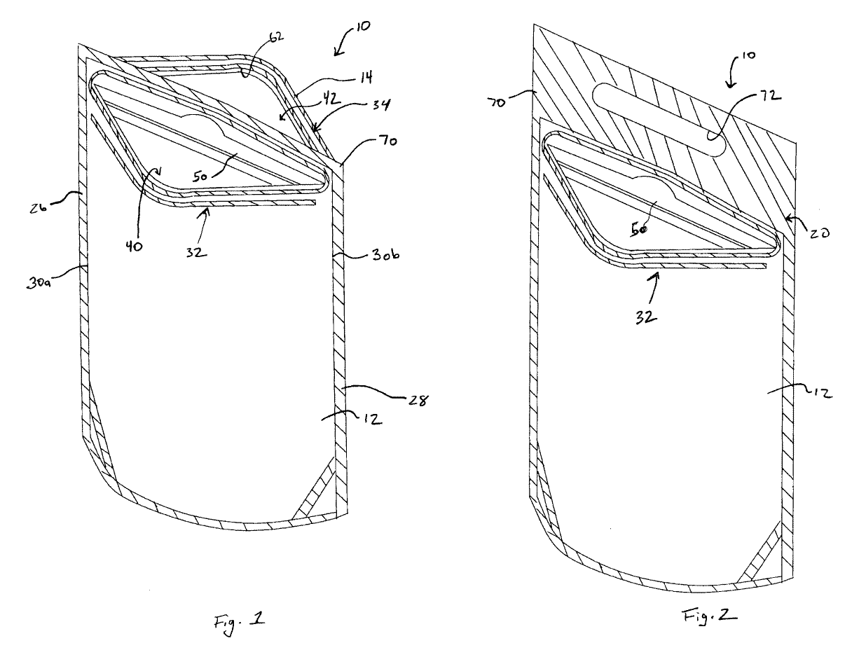

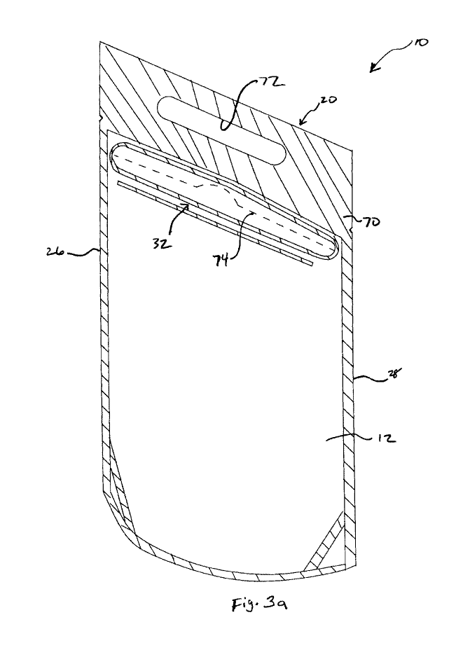

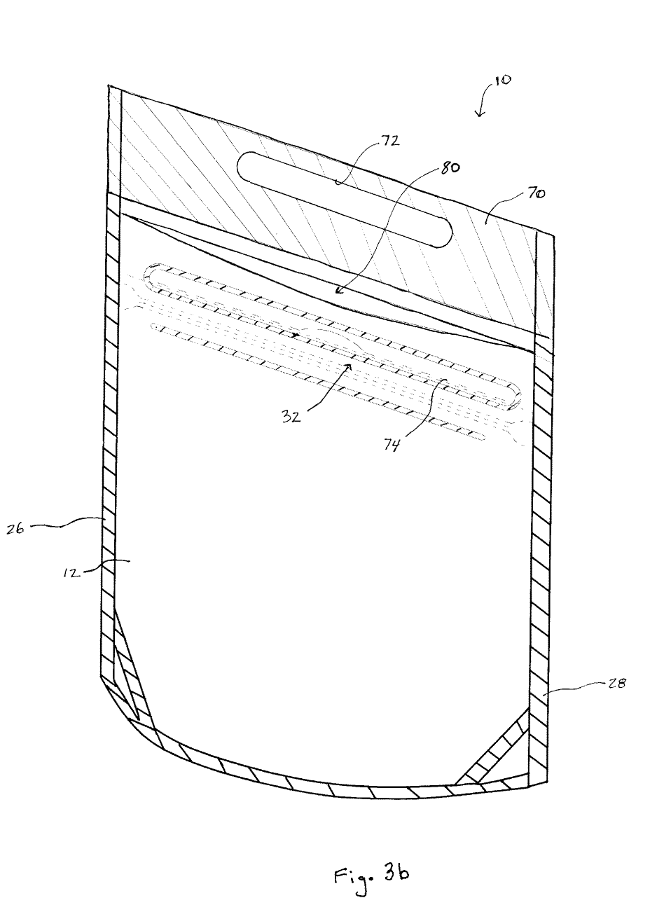

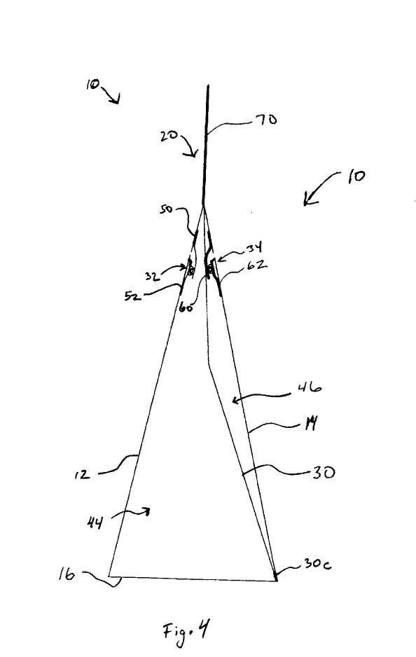

The devices 32, 34 can be re-closeable devices disposed on or integrated to at least one of the front or back panel portions 12,14, and capable of multiple re-closeable uses. Generally, the devices 32, 34 are joined to the respective one of the panels 12, 14, without attachment to other adjacent or proximate panels. However, variations in the attachment configuration of the devices 32, 34 can be included in alternative embodiments. As such, as best shown in FIGS. 2-3b, the consumer or end user has the ability to access the product without removing the packaging material above the devices 32, 34 that could result in losing handle 72 or other accessories above the devices 32, 34.

In one embodiment, the package 10 can further include a fill slit or opening 80, as best shown in FIG. 3b, and FIG. 5a. The fill slit 80 is generally disposed between the access device 32 and the top 20, 70 of the package 10 (e.g., above the device 32). As such, the manufacturer or package maker can form the package 10 with a sealed top 20, 70, and closed or sealed access device 32, such that the package 10 can be filled at a later stage or facility through the fill slit 80. This, in turn, means that those filling the package 10 with material or contents will only have to seal off the fill slit 80 after filling, rather than the top 20, 70, which is often thicker, larger or otherwise more difficult to seal. Such an embodiment with a fill slit 80 can be employed in packages having multi-compartments, or those only having a single internal cavity and access device 32, as described further herein. As a result, the fill slit 80 can be positioned above one or both of the devices 32, 34 and employed in a myriad of packages, including all of the packages described herein. For instance, a fill slit 80 can also be employed in a package embodiment with only a single internal compartment and/or a single access into the package 10 or compartment. Alternatively, various embodiments of the package 10 could be filled through an opening or unsealed portion (e.g., top portion) of the package rather than through a fill slit 80.

In one embodiment, a package 10 like those shown in FIGS. 2-3b, can be modified to include just a single access device 32 and single internal compartment or cavity, with the device 32 being attached to only one of the front panel 12 or back panel 14 portions to provide access into the package 10. Such embodiments could, but would not require the use of an internal panel 30 to define multiple internal compartments. The package 10 can include attachment of the access device 32 along or in line with the machining direction during formation of the package 10 rather than at a positioning transverse to the machining direction or prior to formation of the package. Moreover, the fill slit 80 configuration described herein can be employed to facilitate the filling of such a package.

Fixed zippers, slider zippers, adhesives/tapes, snap or screw cap devices, snap fasteners, hook and latch fastening, spouts, fitments, and other like techniques and devices known to one skilled in the art can be employed for use as the access devices 32, 34. The apparatus and methods disclosed in U.S. Pat. Nos. 6,019,512 and 6,516,850 for integrating zippers into a flexible package are incorporated herein by reference. In addition, other machines consistent with that disclosed herein, and known technologies for attaching access opening devices to flexible packaging sheets or webs are also envisioned. The zipper or other access devices 32, 34 can be attached running with (e.g., in line) or transverse to the machine direction associated with the package formation process. Alternative embodiments of the access devices 32, 34 can be single or minimal use access devices, folding flaps, spouts, holes, and the like. For instance, a peel seal as described herein can be included without a zipper interlock portion for such embodiments where re-closeability is not desirable or needed, or incorporated with those embodiments having re-closeable access devices 32, 34. Further, the access device can be disposed along any portion of the package 10 without deviating from the present invention, including but limited to portions along or proximate one or more longitudinal sides of the package 10, the bottom of the package 10, and like configurations. For example, in an alternative embodiment, the access devices 32 or 34 could be provided at the bottom of the package such that access to or dispensing of the material contents could occur at or proximate the package bottom.

Various embodiments of the present invention can include a temporary seal bond along any of the edges or seals of the internal panel 30. Preferably, the temporary seal would be provided along the transverse edge or seal 30c of the internal panel 30 for those embodiments where the seal 30c is a distance above the bottom of the package 10. In one embodiment of the temporary seal, an adhesive, tape, or other selectively engageable material or substance comprises at least a portion of the transverse seal 30c when it is closeably engaged to temporarily bond the transverse edge 30c of the internal panel 30 to the inner surface of one panel of the main package 10 (e.g., the sealant surface of the front panel 12). When the temporary seal is opened or disengaged (through force, application of cooking or heat, and the like), the second compartment 46 is brought into fluid communication with the first compartment 44. Such temporary seal embodiments can be utilized to isolate material contents of the two cavities or compartment 44, 46 until such time as it is needed or desirable. Medical materials and contents, food, gels, liquids, solids, and a myriad of other materials and substances can be segregated for a desired period of time or use and then selectively brought into communication with such an embodiment. Further, communication between the cavities 44, 46 can be closed by engaging or actuating the temporary seal to again provide desired segregation in those embodiments using adhesives, tapes, and the like.

Various embodiments can further include tear or peel portions 24, including slits, scores, perforations, notches, and the like in the package 10. For instance, a tear notch 24 can be provided in the top portion 20, 70 (FIG. 3a) to facilitate removal of at least a section of the top portion 20, 70. Other peel-away or peel-back materials 74, tabs, or tear portions, can be located proximate the openings 40, 42 or the access devices 32, 34 to facilitate selective access to the package 10 openings.

The various formation steps and methods, isolated or combined, or variations thereof, disclosed in U.S. Patent Publication No. 20040031244 can be employed to manufacture or form the package 10 of the present invention. As such, U.S. Patent Publication No. 20040031244 is hereby incorporated by reference herein. Further, various handles, graphics, closeable and re-closeable devices, gusseted portions, and like features known to one skilled in the art are also envisioned for use with this invention and can be implemented without deviating from the spirit and scope of the present invention. All references to front, back, top, bottom, and the like are merely for demonstrative purposes and are not intended to limit the variations and positional references and orientations of the panels in the present invention.

The present invention may be embodied in other specific forms without departing from the spirit or essential attributes thereof, and it is, therefore, desired that the present embodiment be considered in all respects as illustrative and not restrictive. Similarly, the above-described methods and techniques for forming the present invention are illustrative processes and are not intended to limit the methods of manufacturing/forming the present invention to those specifically defined herein. A myriad of various unspecified steps and procedures can be performed to create or form the inventive package 10.

What is claimed is:

1. A method of forming a multi-compartment flexible package, comprising:
providing a first panel including an internal first surface, the first panel running in line with a formation machine direction;
providing a second panel including and an internal second surface, the second panel running in line with the formation machine direction;
providing a central panel intermediate the first panel and the second panel to create first and second internal compartments, the central panel extending to create at least a portion of a top package portion;
sealing a first re-closeable access device to the internal first surface, without sealing to the central panel portion, and in line with the formation machine direction, to create a first opening into the first internal compartment;
sealing a second re-closeable access device to the internal second surface, without sealing to the central panel portion, and in line with the formation machine direction, to create a second opening into the second internal compartment, with the second re-closeable access device provide in opposing alignment with the first re-closeable access device;
forming a first fill slit intermediate the top package portion and the first re-closeable access device; and
forming a second fill slit intermediate the top package portion and the second re-closeable access device.

2. The method of claim 1, wherein a first material is provided into the first internal compartment via the first fill slit.

3. The method of claim 2, wherein the first fill slit is sealed closed.

4. The method of claim 1, wherein a second material is provided into the second internal compartment via the second fill slit.

5. The method of claim 4, wherein the second fill slit is sealed closed.

6. The method of claim 1, wherein the first re-closeable access device includes a first zipper device.

7. The method of claim 1, wherein the second re-closeable access device includes a second zipper device.

8. The method of claim 1, wherein the first re-closeable access device includes first and second flanges attached only to the internal first surface.

9. The method of claim 1, wherein the second re-closeable access device includes first and second flanges attached only to the internal second surface.

10. The method of claim 1, wherein the top package portion includes a handle portion.

11. The method of claim 1, wherein the top package portion includes a tear portion enabling removal of at least a portion of the top package portion.

12. The method of claim 1, further including providing a bottom panel.

13. A method of forming a multi-compartment flexible package, comprising:
providing a first panel including first longitudinal edges and an internal first surface, the first panel running in line with a formation machine direction;
providing a second panel including second longitudinal edges and an internal second surface, the second panel running in line with the formation machine direction;
providing a central panel intermediate the first panel and the second panel to create first and second internal compartments, the central panel extending to create at least a portion of a top package portion;
sealing a first re-closeable access device to the internal first surface, without sealing to the central panel portion, and in line with the formation machine direction, to create a first opening into the first internal compartment that extends a distance short of the first longitudinal edges;
sealing a second re-closeable access device to the internal second surface, without sealing to the central panel portion, and in line with the formation machine direction, to create a second opening into the second internal compartment that extends a distance short of the second longitudinal edges, with the second re-closeable access device provide in opposing alignment with the first re-closeable access device;
forming a first fill slit intermediate the top package portion and the first re-closeable access device; and
forming a second fill slit intermediate the top package portion and the second re-closeable access device.

14. The method of claim 13, wherein a first material is provided into the first internal compartment via the first fill slit and a second material is provided into the second internal compartment via the second fill slit.

15. The method of claim 14, wherein the first and second fill slits are sealed closed.

16. The method of claim 13, wherein the first re-closeable access device includes a first zipper device.

17. The method of claim 13, wherein the second re-closeable access device includes a second zipper device.

18. The method of claim 13, wherein at least the first re-closeable access device includes a top flange and a bottom flange attached only to the internal first surface such that the first fill slit is formed proximate the top flange of the first re-closeable access device.

19. The method of claim 13, wherein the top package portion includes a tear portion enabling removal of at least a portion of the top package portion.

20. The method of claim 13, further including providing a bottom panel.
